(19) United States
(12) Patent Application Publication
(10) Pub. No.: US 2009/0032691 A1
(43) Pub. Date: Feb. 5, 2009

(54) PHOTOELECTRIC ENCODER AND ELECTRONIC EQUIPMENT USING THE SAME

(75) Inventor: Masato SASAKI, Nara-ken (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/180,774

(22) Filed: Jul. 28, 2008

(30) Foreign Application Priority Data
Jul. 31, 2007 (JP) 2007-198682

(51) Int. Cl. G01D 5/34

(52) U.S. Cl. 250/231.13

(57) ABSTRACT

In a photoelectric encoder, each of light receiving elements (33a-33d) has a parallelogram shape formed by adjoining two congruent triangular light receiving regions (B), which each have a height dx1 with a dy1-long base edge, where one light receiving region (B) is adjacent to another with their base edges being coincident with each other. The base edge extends in a Y direction, while the height direction against the base edge is an X direction. Trailing and leading edges of detection signals from comparators (34, 36) are made abrupt to reduce jitter. A total light reception area of 4×(dx1)×(dy1) is obtained from regions whose total area is 4×(dx1)×(dy1+α), so that setting ‘α’ (α>0) to a small one allows the light efficiency to be greatly improved.

This nonprovisional application claims priority under 35 U.S.C. §119(a) on Patent Application No. 2007-198682 filed in Japan on Jul. 31, 2007, the entire contents of which are hereby incorporated by reference.

### BACKGROUND OF THE INVENTION

The present invention relates to a photoelectric encoder, as well as an encoder device, on which a plurality of light receiving elements are mounted.

As a device for detecting motions, such as rectilinear motion and rotational motion, of a detection object and inputting those motions to digital equipment such as a computer, there has conventionally been used an encoder device which generates pulses responsive to motions of the detection object.

The encoder device is made up roughly of a member in which a plurality of openings are arrayed and which moves along the array direction of the plurality of openings, a light receiving element for detecting light which has passed through the openings, and a signal processing section for producing output pulses based on detection outputs from individual light receiving parts of the light receiving element.

FIG. 6 show an example of construction of a conventional encoder device, in which FIG. 6(a) is a plan view, and FIG. 6(b) is a side view.

The encoder device 1 is composed roughly of a light source 2, a slit member 3, and a light receiving unit 4. The light source 2 and the light receiving unit 4 are fitted and fixed in a manner that those units are spaced from each other and opposed to each other with the slit member 3 interposed therebetween. The slit member 3, which is disposed between the light source 2 and the light receiving unit 4, is movable relative to the light source 2 and the light receiving unit 4 in an X1 direction (rightward direction in FIG. 6) or in an X2 direction (i.e. the leftward direction in the figure). That is, the slit member 3, which is fixed to the detection object, moves along an X direction (in an X1 direction or an X2 direction) as the detection object moves.

In the light receiving unit 4, light receiving elements 4a, 4b, 4c, 4d implemented by rectangular photodiodes or the like are arrayed in adjacency to one another in the X direction. The light receiving elements 4a, 4b, 4c, 4d each have an X-direction width set to dx1 and a Y-direction length set to dy1, so that the light receiving elements 4a, 4b, 4c, 4d are of the same light reception area. In the slit member 3, light transmitting portions 3a and light shielding portions 3b are alternately and arrayed alternately in adjacency to one another along the X direction. Each of the light transmitting portions 3a and the light shielding portions 3b has an X-direction width dx2 which is set to ‘2×dx1’, and a Y-direction length dy2 which is set to ‘dy1+α’ (>dy1).

Output signals of the light receiving elements 4a, 4c are compared with each other by a comparator 5, and a comparison result thereof is outputted as a detection signal VoutA from a terminal 6. Also, output signals of the light receiving elements 4b, 4d are compared with each other by a comparator 7, and a comparison result thereof is outputted as a detection signal VoutB from a terminal 8.

In this case, when the slit member 3 moves in an X1 direction relative to the light receiving unit 4, the output signal VoutB of the comparator 7 results in a waveform which is delayed by a ¼ cycle from that of the output signal VoutA of the comparator 5. On the other hand, when the slit member 3 moves in the X2 direction relative to the light receiving unit 4, the output signal VoutA of the comparator 5 results in a waveform which is delayed by a ¼ cycle from that of the output signal VoutB of the comparator 7.

Unfortunately, in the conventional encoder device 1, edges of the light receiving elements 4a, 4b, 4c, 4d are formed parallel to borderlines between the light transmitting portions 3a and the light shielding portions 3b in the slit member 3. Because of this, output signals of the light receiving elements 4a-4d result in monotonically increasing or monotonically decreasing waveforms, which leads to a problem of increased jitter.

Accordingly, for solution to such problems concerning jitter as mentioned above, there has been proposed an encoder device, such as one disclosed in JP 2007-10426 A (Patent Document 1), which is capable of reducing jitter at leading edges and trailing edges of detection signals. FIG. 7 shows a planar construction of an encoder device 11 disclosed in Patent Document 1.

The encoder device 11 is made up roughly of a light source (not shown), a slit member 12, and a light receiving unit 13. The light source and the light receiving unit 13 are fitted and fixed in a manner that they are spaced from each other and opposed to each other with the slit member 12 interposed therebetween. The slit member 12, which is disposed between the light source and the light receiving unit 13, is movable relative to the light source and the light receiving unit 13 in an X1 direction (rightward direction in FIG. 7) or in an X2 direction (i.e. the leftward direction in the figure). That is, the slit member 12, which is fixed to the detection object, moves along the X direction as the detection object moves.

In the light receiving unit 13, as shown in FIG. 7, light receiving elements 13a, 13b, 13c, 13d implemented by rhombic photodiodes or the like are arrayed in adjacency to one another in the X direction in such a way that straight lines passing through two pairs of mutually opposed vertices of the rhombic shape become parallel to the X axis and the Y axis, respectively. It is noted that the shape of each light receiving element may be a square one, instead. The light receiving elements 13a, 13b, 13c, 13d each have an X-direction width dx3 set to dx1 (which is the X-direction width of the light receiving elements 4a-4d in FIG. 6) and a Y-direction length dy3 set to ‘2×dy1’ (which is the Y-direction length of the light receiving elements 4a-4d in FIG. 6), so that the light receiving elements 13a, 13b, 13c, 13d are of the same light reception area.

In the slit member 12, as shown in FIG. 7, light transmitting portions 12a and light shielding portions 12b are arrayed alternately in adjacency to one another along the X direction. Each of the light transmitting portions 12a and the light shielding portions 12b has an X-direction width dx4 set to ‘2×dx3’ and a Y-direction length dy4 set to ‘dy3+α’ (=2×dy1+α>2×dy1).

Output signals of the light receiving elements 13a, 13c are compared with each other by a comparator 14, and a comparison result thereof is outputted as a detection signal VoutA from a terminal 15. Also, output signals of the light receiving elements 13b, 13d are compared with each other by a comparator 16, and a comparison result thereof is outputted as a detection signal VoutB from a terminal 17.

In this case, when the slit member 12 moves at a constant speed in an X1 direction relative to the light receiving unit 13, the output signal of the light receiving element 13a, as shown in FIG. 8(a), shows a rate of increase which gradually increases from time t0 to time t1/2 (=τ/2), reaching a maximum at time t1/2 (=τ/2), and thereafter gradually decreases until time t1 (=τ). Also, the output signal shows a rate of decrease which gradually increases from time t2 to time ‘t2+τ/2’, reaching a maximum at time ‘t2+τ/2’, and thereafter gradually decreases until time t3 (=t2+τ).

Meanwhile, an output signal of the light receiving element 13c, as shown in FIG. 8(c), shows a rate of decrease which gradually increases from time t0 to time t1/2 (=τ/2), reaching a maximum at time t1/2 (=τ/2), and thereafter gradually decreases until time t1 (=τ). Also, the output signal shows a rate of increase which gradually increases from time t2 to time ‘t2+τ/2’, reaching a maximum at time ‘t2+τ/2’, and thereafter gradually decreases until time t3 (=t2+τ).

Therefore, a detection signal outputted from the comparator 14, as shown in FIG. 8(e), abruptly falls at a time point when the time duration τ/2 has elapsed since the time t0, and abruptly rises at a time point when the time duration τ/2 has elapsed since the time t2. Thus, jitter at leading edges and trailing edges of the detection signal VoutA is greatly reduced.

Similarly, when the slit member 12 moves at a constant speed in an X1 direction relative to the light receiving unit 13, the output signal of the light receiving element 13b, as shown in FIG. 8(b), shows a rate of increase which gradually increases from time t1 to time ‘t1+τ/2’, reaching a maximum at time ‘t1+τ/2’, and thereafter gradually decreases until time t2 (=t1+τ). Also, the output signal shows a rate of decrease which gradually increases from time t3 to time ‘t3+τ/2’, reaching a maximum at time ‘t3+τ/2’, and thereafter gradually decreases until time t4 (=t3+τ).

Meanwhile, an output signal of the light receiving element 13d, as shown in FIG. 8(d), shows a rate of decrease which gradually increases from time t1 to time ‘t1+τ/2’, reaching a maximum at time ‘t1+τ/2’, and thereafter gradually decreases until time t2 (=t1+τ). Also, the output signal shows a rate of increase which gradually increases from time t3 to time ‘t3+τ/2’, reaching a maximum at time ‘t3+τ/2’, and thereafter gradually decreases until time t4 (=t3+τ).

Therefore, a detection signal outputted from the comparator 16, as shown in FIG. 8(f), abruptly falls at a time point when the time duration τ/2 has elapsed since the time t1, and abruptly rises at a time point when the time duration τ/2 has elapsed since the time t3. Thus, jitter at leading edges and trailing edges of the detection signal VoutB is greatly reduced.

In the encoder device 11, in a rectangular-shaped region having an area of 2×(dy1)×4×(dx1)=8×(dy1)×(dx1), rhombic-shaped light receiving elements 13a-13d are arrayed in adjacency to one another, resulting in a total light reception area of 4×(dy1)×(dx1). Thus, there is a problem that the light reception efficiency relative to the rectangular-shaped region is reduced to 50%.

As a solution to such problems concerning jitter as described above, there has been proposed an encoder device, such as an encoder device disclosed in JP 2007-12904 A (Patent Document 2), which is capable of reducing jitter at leading edges and trailing edges of detection signals. FIG. 9 shows a planar construction of an encoder device 21 disclosed in Patent Document 2.

The encoder device 21 is made up roughly of a light source (not shown), a slit member 22, and a light receiving unit 23. The light receiving unit 23 is made up of eight light receiving elements 23a, 23b, 23c, 23d, 23e, 23f, 23g, 23h. Each of the light receiving elements 23a-23h outputs an output signal responsive to a quantity of incident light transmitted by a light transmitting portion 22a of the slit member 22.

Each of the light receiving elements 23a, 23c, 23e, 23g is so made up that n (three in this example) light receiving regions A1 arrayed in the Y direction are coupled to one another. Then, the n (three) light receiving regions A1 are each formed in a rectangular shape (e.g., generally square shape) of the same size, and moreover are coupled to one another at their vertices located on diagonal lines running in the Y direction.

In contrast to this, each of the light receiving elements 23b, 23d, 23f, 23h is so made up that (n−1) (two in this example) rectangular-shaped light receiving regions A1 and two triangular-shaped light receiving regions A2 arrayed in the Y direction are coupled to each other. The (n−1) (two) light receiving regions A1 are each formed in a rectangular shape (e.g., generally square shape) of the same size, and are coupled to one another at their vertices located on a diagonal line running in the Y direction. Further, the two light receiving regions A2 are each formed in a triangular shape obtained by cutting a light receiving region A1 by a diagonal line in the X direction, and their generally right-angled vertices are coupled to respective end-vertices of the (n−1) (two) light receiving regions A1.

The light receiving elements 23a-23h are so placed that sides of their light receiving regions A1, A2 overlap, one on one, with sides of light receiving regions A1, A2 of their adjoining light receiving elements 23a-23h. With this placement, the light receiving elements 23a-23h are placed in a small area. In addition, the light receiving elements 23a-23h, by their being formed into such configurations as described above, have generally equal light reception area allocated therefor. With such an arrangement of the light receiving elements 23a-23h, the problem that the light reception efficiency of the encoder device 11 disclosed in Patent Document 1 is reduced to 50% is solved.

The X-direction width dx5 of the light receiving regions A1, A2 in each of the light receiving elements 23a-23h is set to one half of an X-direction width dx6 of each of the light transmitting portion 22a and the light shielding portion 22b of the slit member 22. That is, the X-direction width dx6 of the light transmitting portion 22a and the light shielding portion 22b of the slit member 22 is set to ‘2×dx5’. Also, a Y-direction length dy6 of each of the light transmitting portion 22a and the light shielding portion 22b of the slit member 22 is set to dy5+α (>dy5), where dy5 is the Y-direction length of each of the light receiving elements 23a-23h. In this case, the length dy5 of each of the light receiving elements 23a-23h is set to ‘2×dy1’, which is a double of the Y-direction length dy1 of each of the light receiving elements 4a-4d in FIG. 6.

Accordingly, in the encoder device 21, in which the light receiving region A1 is formed into a rectangular shape and the light receiving region A2 is formed into a triangular shape, output signals of the light receiving elements 23a-23h show more abrupt leading edges and trailing edges so that jitter is greatly reduced.

However, the conventional encoder device 21 disclosed in Patent Document 2 has the following problem. That is, the encoder device 21 is so arranged that the light receiving regions A1 are coupled to one another, and that the light receiving regions A1 and the light receiving regions A2 are coupled to each other. Therefore, while borders between the light transmitting portions 22a and the light shielding portions 22b in the slit member 22 is passing through those coupling portions, output signals from the individual light receiving elements 23a-23h have a monotonically increasing or monotonically decreasing waveform, so that the extent of reduction of jitter decreases.

Further, the light receiving elements 23a, 23c, 23e, 23g and the light receiving elements 23b, 23d, 23f, 23h, although having generally equal light reception areas, yet are not identical in configuration thereamong, thus having another problem that their output signals may be biased.

### SUMMARY OF THE INVENTION

Accordingly, an object of the present invention is to provide a photoelectric encoder capable of reducing jitter without causing deterioration of light reception efficiency, as well as electronic equipment using the photoelectric encoder.

In order to achieve the above object, there is provided a photoelectric encoder comprising:

a light emitting part;

a light receiving part for receiving light emitted from the light emitting part; and

a movable member in which first regions for transmitting or reflecting light emitted from the light emitting part toward the light receiving part and second regions different in light transmittance or optical reflectance from the first regions are alternately arrayed along a moving direction of the movable member, borders between the first regions and the second regions extending along a direction perpendicular to the moving direction, wherein

the light receiving part comprises a plurality of identical light receiving elements which are arranged along the moving direction of the movable member, the light receiving elements are shaped such that each light receiving element is actually or imaginarily dividable into two congruent triangular light receiving regions and that the two congruent triangular light receiving regions are adjacent to each other, with an edge of one triangular light receiving region being coincident with a corresponding edge of the other triangular light receiving region, and

opposite edges in the moving direction of each of the light receiving elements are parallel to or coincident with edges of the light receiving elements adjoining thereto in the moving direction, and moreover inclined at a non-right angle with respect to the moving direction.

In this photoelectric encoder, each light receiving element is shaped such that the two congruent triangles of the light receiving regions are adjacent to each other, with an edge of one triangle being coincident with a corresponding edge of the other triangle, and opposite edges in the moving direction of the light receiving element are parallel to or coincident with edges of the light receiving elements adjoining thereto in the moving direction, and moreover inclined at a non-right angle with respect to the moving direction. Therefore, edges of the individual light receiving elements are not parallel to borders between the first region and the second region that extend along a direction perpendicular to the moving direction in the movable member. Because of this, leading and trailing edges of output signals from the light receiving elements result in a waveform which is not of monotonic increase or monotonic decrease but of a shape close to a sine wave, showing an abrupt degree of increase and decrease. Thus, jitter of detection signals from the movable member produced based on the output signals from the light receiving elements can be reduced.

In one embodiment, the light receiving elements making up the light receiving part each have a parallelogram shape.

In this embodiment, the light receiving elements each have a parallelogram shape. Therefore, all the light receiving elements can be adjacently arranged along the moving direction of the movable member without inverting their direction. Thus, biases among output signals of the light receiving elements can be reduced.

In one embodiment, the two congruent triangular light receiving regions, into which each of the light receiving elements is actually or imaginarily dividable, each have a shape of a right-angled triangle. And, the light receiving elements each have an isosceles triangular shape which is formed by adjoining the two congruent right-angled triangles of the light receiving regions to each other with their 90-degree angles set adjacent to each other.

In this embodiment, the light receiving elements each have an isosceles triangular shape. Therefore, all the light receiving elements can be arranged successively, with no gaps therebetween, in the moving direction of the movable member by inverting their orientation. Thus, the light reception efficiency may become 100%, so that output signals of the light receiving elements can be obtained with high efficiency.

In one embodiment, the two congruent triangular light receiving regions, into which each of the light receiving elements is actually or imaginarily dividable, each have a shape of a right-angled triangle. And, the light receiving elements each have a shape in which the two congruent right-angled triangles of the light receiving regions are adjoined to each other, with one of two edges making a right angle therebetween of one right-angled triangle being coincident with a corresponding edge of the other right-angled triangle so that the right angle of one right-angled triangle and a non-right angle of the other right-angled triangle are adjacent to each other.

In this embodiment, the light receiving elements are so shaped as to be in point symmetry. Therefore, all the light receiving elements can be arranged adjacently to each other, with no gaps therebetween, in the moving direction of the movable member without inverting their orientation. Thus, biases among output signals of the light receiving elements can be reduced. Further, the light reception efficiency may become 100%, so that output signals of the light receiving elements can be obtained with high efficiency.

In one embodiment, the light receiving elements each have a zigzag shape in which a plurality of the parallelogram-shaped light receiving regions, each formed of two adjoining congruent right-angled triangular light receiving regions, are combined in such a manner that an edge of one parallelogram-shaped light receiving region is coincident with a corresponding edge of another parallelogram-shaped light receiving region and that these two light receiving regions are in line symmetry with respect to the coincident edges.

In this embodiment, the light receiving elements each have a zigzag shape. Therefore, edges of the light receiving elements which are not parallel to borders between the adjoining first and second regions in the movable member can be subdivided. Thus, quantities of incident light to the individual light receiving elements, and hence output signals, can be averaged.

In one embodiment, the light receiving elements are arranged successively in a quantity of (2×n), where n is an integer satisfying that n≧2, at a pitch which is one (2×n)-th of an array pitch P of the first regions or the second regions in the movable member. And, the photoelectric encoder further comprises a signal processing part for, based on output signals from the (2×n) light receiving elements, generating two rectangular waves which differ in phase from each other by 360°/2n and each of which has a cycle period of (2/n)×T, the rectangular waves being produced every one cycle T in which the first regions and the second regions in the movable member move by the array pitch P.

In this embodiment, it becomes possible to obtain abrupt leading and trailing edges of (2×n) output signals for the signal processing part which differ in phase from each other by 360°/(2n) and which have a cycle period of T. Therefore, jitter can be reduced in two rectangular waves which differ in phase from each other by 360°/2n and each of which has a cycle period of (2/n)×T, the rectangular waves being produced by the signal processing part every cycle T in which the first region and the second region in the movable member move by the array pitch P.

According to the present invention, there is also provided electronic equipment including the above-described photoelectric encoder of the invention.

In this case, since the electronic equipment includes a photoelectric encoder capable of reducing jitter of detection signals of the movable member produced based on output signals from the light receiving elements, displacement quantity and direction of displacement of the movable member are detected with high precision based on the detection signals. Therefore, proper operations can be fulfilled by using those detection results.

As apparent from the above description, in the photoelectric encoder according to the invention, the light receiving elements are each so made up as to have a shape that two congruent triangular light receiving regions are adjoined to each other with their mutually corresponding edges coincidentally placed, where opposite edges of the light receiving elements in their moving direction are inclined at a non-right angle with respect to the moving direction. Therefore, the edges of the individual light receiving elements are not parallel to borders between the adjacent first and second regions of the movable member that extend along a direction perpendicular to the moving direction. Because of this, leading and trailing edges of output signals from the light receiving elements result in a waveform which is not of monotonic increase or monotonic decrease but of a shape close to a sine wave, showing an abrupt degree of increase and decrease. Thus, jitter of detection signals from the movable member produced based on the output signals from the light receiving elements can be reduced.

Further, when the light receiving elements are each formed in a parallelogram shape, all the light receiving elements can be adjacently arranged in the moving direction of the movable member without inverting the light receiving elements. Thus, biases among output signals of the light receiving elements can be reduced.

Further, when the light receiving elements are each formed into a parallelogram or isosceles-triangle shape by combining two congruent right-angled triangular-shaped light receiving regions, into which each light receiving element can actually or imaginarily be divided, all the light receiving elements can be arranged, with no gaps therebetween, in the moving direction of the movable member. Thus, the light reception efficiency can be 100%, so that output signals of the light receiving elements can be obtained with high efficiency.

Since the electronic equipment of the present invention includes a photoelectric encoder capable of reducing jitter of detection signals from the movable member produced based on output signals from the light receiving elements, displacement quantity and direction of displacement of the movable member can be detected with high precision based on the detection signals. Therefore, proper operations can be fulfilled by using those detection results.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a view showing a planar construction of a photoelectric encoder according to the present invention;

FIGS. 2(a)-(f) are diagrams showing waveforms of output signals of individual light receiving elements and comparators in FIG. 1;

FIG. 3 is a view showing a planar construction of a photoelectric encoder different from that of FIG. 1;

FIG. 4 is a view showing a planar construction of a photoelectric encoder different from those of FIGS. 1 and 3;

FIG. 5 is a view showing a planar construction of a photoelectric encoder different from those of FIGS. 1, 3 and 4;

FIGS. 6(a) and 6(b) are views showing an example of construction of an encoder device according to background art;

FIG. 7 is a view showing a planar construction of a background art photoelectric encoder different from those of FIGS. 6(a) and 6(b);

FIGS. 8(a)-(f) are diagrams showing waveforms of output signals of individual light receiving elements and comparators in FIG. 7; and

FIG. 9 is a view showing a planar construction of background art photoelectric encoder different from those of FIGS. 6(a) and 6(b) and FIG. 7.

### DETAILED DESCRIPTION OF THE INVENTION

Hereinbelow, the present invention will be described in detail by way of embodiments thereof illustrated in the accompanying drawings.

### First Embodiment

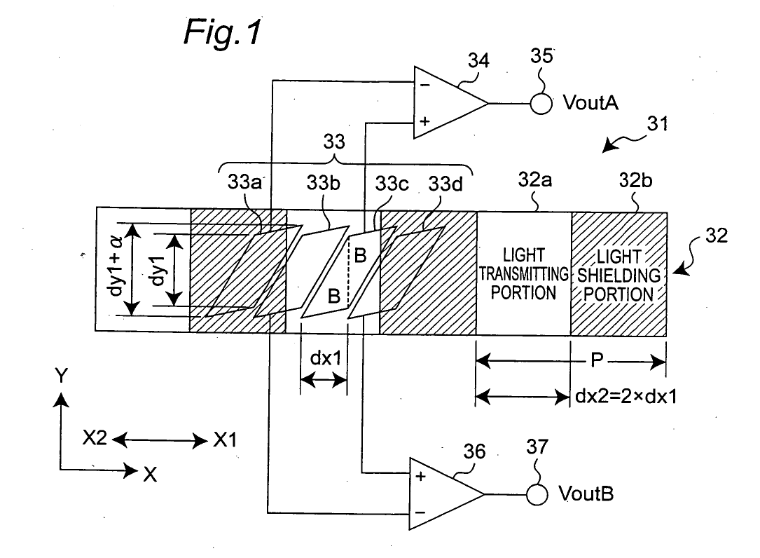

FIG. 1 shows a planar construction of a photoelectric encoder 31 of this embodiment.

This photoelectric encoder 31 is made up roughly of a light source (not shown), a slit member 32, and a light receiving unit 33. The light source and the light receiving unit 33 are fitted and fixed in a manner that they are spaced from each other and opposed to each other with the slit member 32 interposed therebetween. In the slit member 32, light transmitting portions 32a as the first regions and light shielding portions 32b as the second regions are arrayed alternately in adjacency to one another along an X direction. The slit member 32, which is disposed between the light source and the light receiving unit 33, is movable relative to the light source and the light receiving unit 33 in an X1 direction (i.e. the rightward direction in FIG. 1) or an X2 direction (i.e. the leftward direction in the figure). That is, the slit member 32, which is fixed to a detection object, moves along the X direction as the detection object moves.

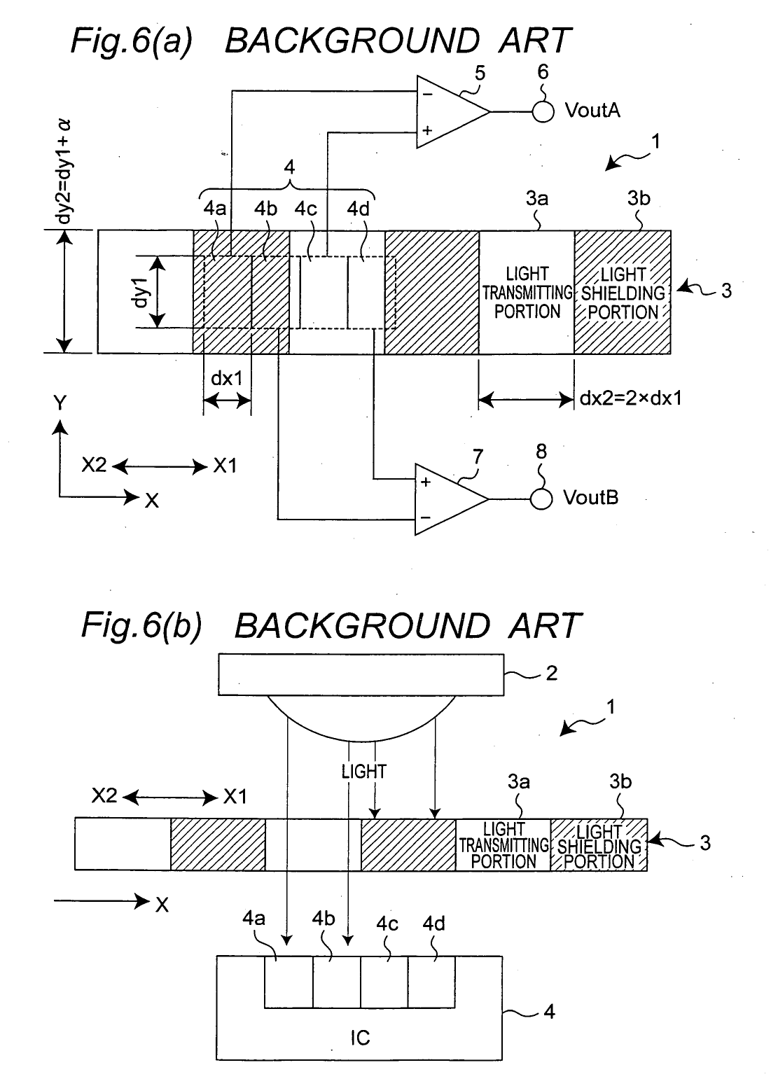

In the light receiving unit 33, as shown in FIG. 1, four light receiving elements 33a, 33b, 33c, 33d implemented by parallelogram-shaped photodiodes or the like are arrayed in adjacency to one another in the X direction. The light receiving elements 33a, 33b, 33c, 33d each have a parallelogram shape such that they are each actually or imaginarily dividable into two congruent triangular light receiving regions B, and the two congruent triangular light receiving regions B are adjacent to each other, with an edge of one triangular light receiving region B being coincident with a corresponding edge of the other triangular light receiving region B. Then, the light receiving regions B each have a height of dx1 (i.e. the X-direction width of the background art light receiving elements 4a-4d in FIG. 6) on the basis that an edge having a length of dy1 (i.e. the Y-direction length of the background art light receiving elements 4a-4d in FIG. 6) is assumed as the base edge, where the light receiving regions B are set in adjacency to other light receiving regions B with their base edges being coincident with each other. Besides, the base edges extend along the Y direction, while the heightwise direction of the light receiving regions B relative to the base edges is along the X direction. Accordingly, the X-direction width of the light receiving elements 33a-33d is set to a double of the X-direction width dx1 of the light receiving elements 4a-4d in the background art encoder device 1 shown in FIG. 6, while their Y-direction length is set to ‘dy1+α’ (>dy1).

That is, four (2×n, where n=2) light receiving elements 33a-33d are arranged successively at a pitch which is a quarter (1/(2×n), where n=2) of a pitch P (4×(dx1)) of the light transmitting portions 32a in the slit member 32. Accordingly, the light reception area of each of the light receiving elements 33a-33d results in (dx1)×(dy1), which is equal to that of the light receiving elements 4a-4d in the background art encoder device 1.

Referring to FIG. 1, output signals of the light receiving elements 33a, 33c are compared with each other by a comparator 34, and a comparison result thereof is outputted as a detection signal VoutA from a terminal 35. Also, output signals of the light receiving elements 33b, 33d are compared with each other by a comparator 36, and a comparison result thereof is outputted as a detection signal VoutB from a terminal 37.

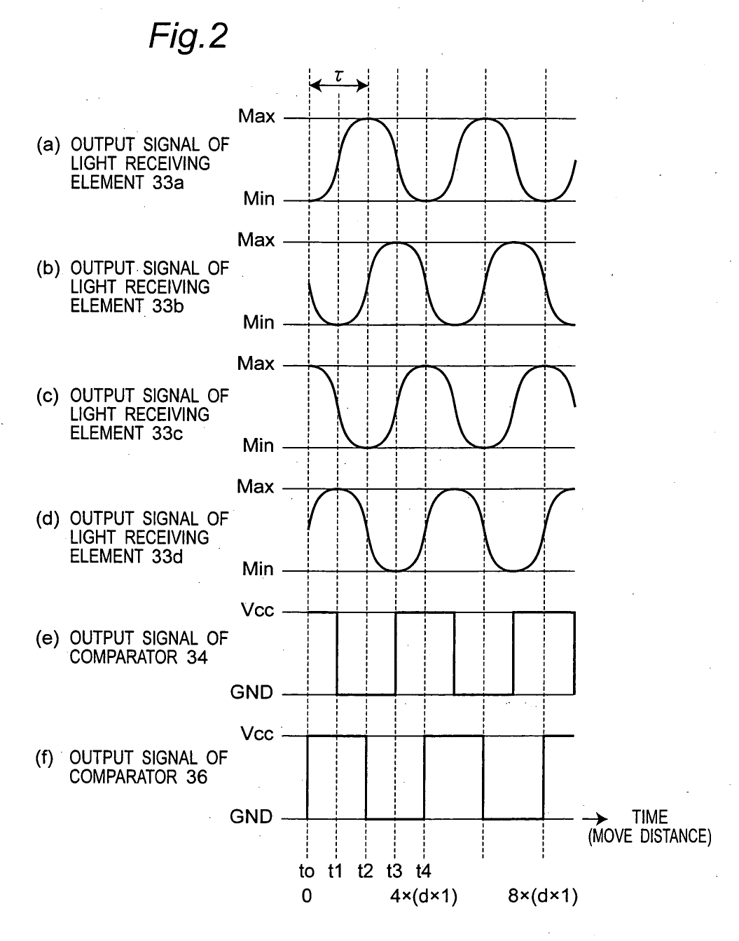

In this case, when the slit member 32 moves at a constant speed in an X1 direction relative to the light receiving unit 33, the output signal of the light receiving element 33a shows a rate of increase which, as shown in FIG. 2(a), gradually increases from time t0 to time t1 (elapsed time τ/2), reaching a maximum at time t1 (τ/2), and thereafter gradually decreases until time t2 (τ). Also, the output signal shows a rate of decrease which gradually increases from time t2 (τ) to time t3 (3τ/2), reaching a maximum at time t3 (3τ/2), and thereafter gradually decreases until time t4 (2τ).

Meanwhile, an output signal of the light receiving element 33c, as shown in FIG. 2(c), shows a rate of decrease which gradually increases from time t0 to time t1 (elapsed time τ/2), reaching a maximum at time t1 (τ/2), and thereafter gradually decreases until time t2 (τ). Also, the output signal shows a rate of increase which gradually increases from time t2 (τ) to time t3 (3τ/2), reaching a maximum at time t3 (3τ/2), and thereafter gradually decreases until time t4 (2τ).

Therefore, a detection signal outputted from the comparator 34, as shown in FIG. 2(e), abruptly falls at the time point t1 when the time duration τ/2 has elapsed since the time point t0, and abruptly rises at the time point t3 when the time duration τ/2 has elapsed since the time point t2. Thus, jitter at leading edges and trailing edges of the detection signal VoutA can be greatly reduced.

Similarly, when the slit member 32 moves at a constant speed in an X1 direction relative to the light receiving unit 33, the output signal of the light receiving element 33b shows a rate of increase, as shown in FIG. 2(b), which gradually increases from time t1 to time t2 (elapsed time τ/2), reaching a maximum at time t2 (τ/2), and thereafter gradually decreases until time t3 (τ). Also, the output signal shows a rate of decrease which gradually increases from time t3 (τ) to time t4 (3τ/2), reaching a maximum at time t4 (3τ/2), and thereafter gradually decreases until time ‘t4+(τ/2)’.

Meanwhile, an output signal of the light receiving element 33d, as shown in FIG. 2(d), shows a rate of decrease which gradually increases from time t1 to time t2 (elapsed time τ/2), reaching a maximum at time t2 (τ/2), and thereafter gradually decreases until time t3 (τ). Also, the output signal shows a rate of increase which gradually increases from time t3 (τ) to time t4 (3τ/2), reaching a maximum at time t4 (3τ/2), and thereafter gradually decreases until time ‘t4+(τ/2)’.

Therefore, a detection signal outputted from the comparator 36, as shown in FIG. 2(f), abruptly falls at the time point t2 when the time duration τ/2 has elapsed since the time point t1, and abruptly rises at the time point t4 when the time duration τ/2 has elapsed since the time point t3. Thus, jitter at leading edges and trailing edges of the detection signal VoutB can be greatly reduced.

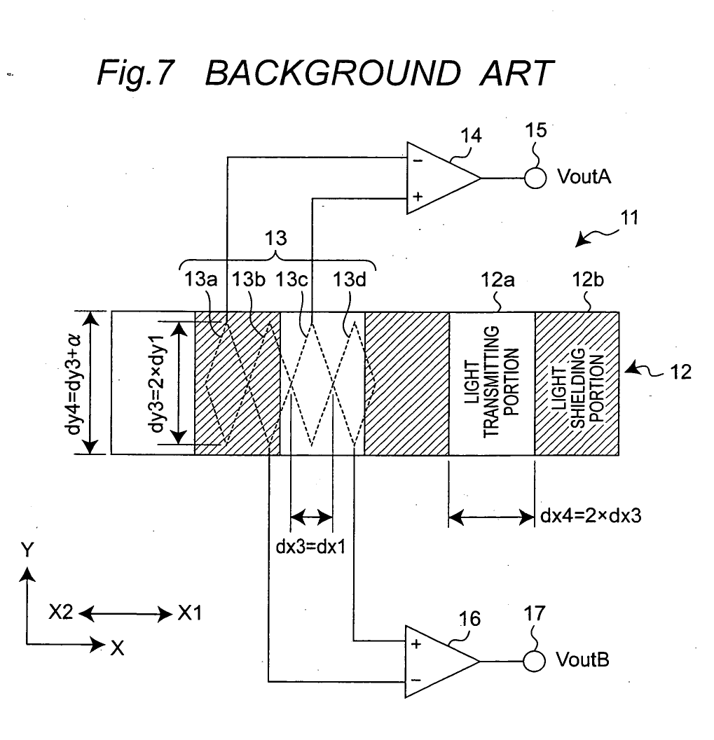

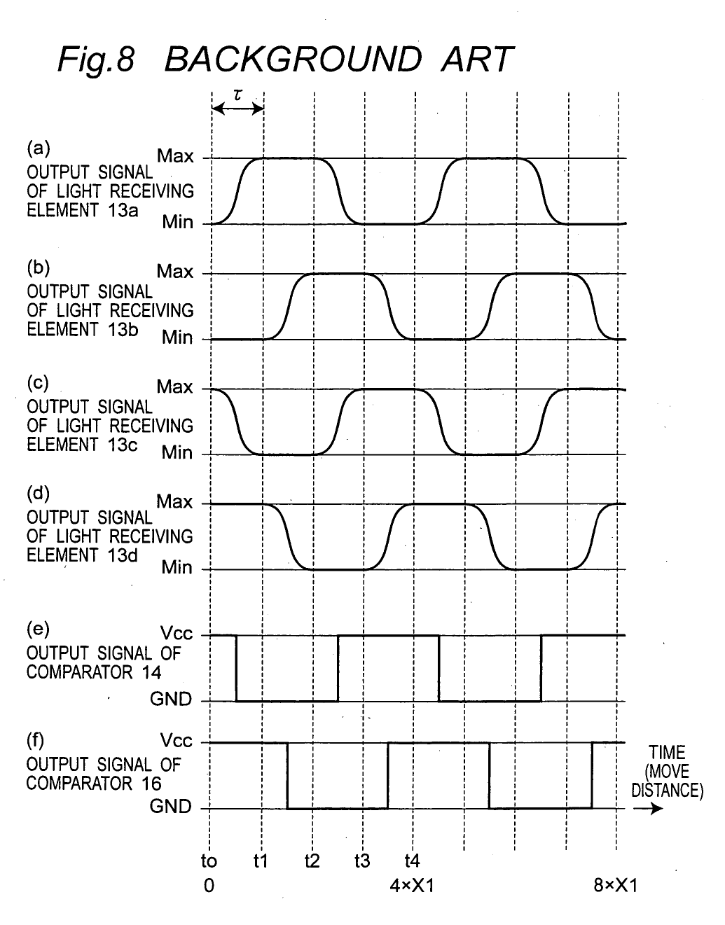

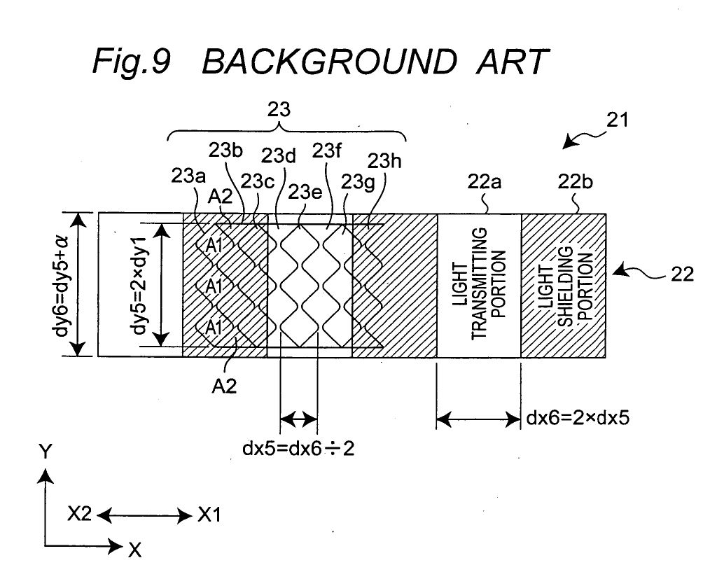

Further, as can be seen from FIGS. 2(e) and 2(f), the detection signal VoutA and the detection signal VoutB in this photoelectric encoder 31 have rectangular waves each of which has a cycle period of T ((2/n)×T, where n=2) and which differ in phase from each other by 90 degrees (360°/2n, where n=2) for each one cycle T in which the light transmitting portions 32a of the slit member 32 move by a pitch P (4×(dx1)). Thus, a detection signal VoutA and a detection signal VoutB of the same waveform as in the background art encoder device disclosed in the foregoing Patent Document 1 shown in FIGS. 7 and 8 can be obtained.

Also in this embodiment, in a rectangular region having an area of 4×(dx1)×(dy1+α), a total light reception area of 4×(dx1)×(dy1) of the light receiving elements 33a-33d can be obtained. Thus, by setting α (α>0) smaller, the light reception efficiency can be greatly improved, compared with the light reception efficiency 50% of the background art encoder device disclosed in Patent Document 1.

### Second Embodiment

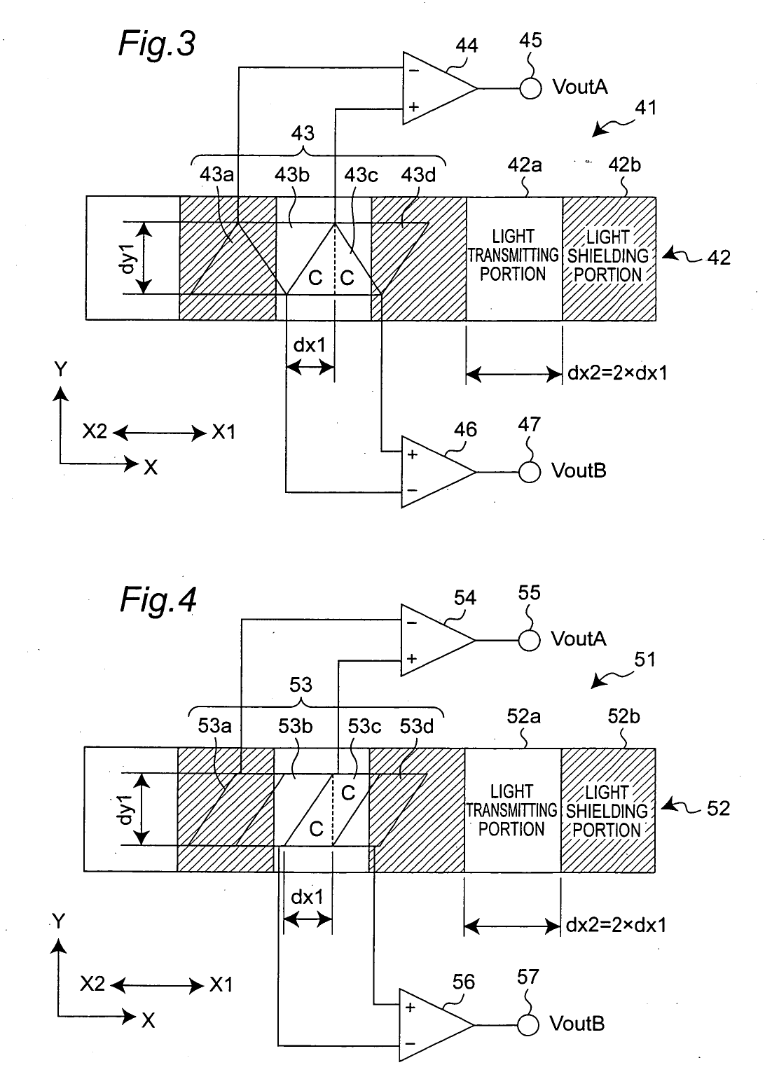

FIG. 3 shows a planar construction of a photoelectric encoder 41 of this embodiment.

The photoelectric encoder 41 is made up roughly of a light source (not shown), a slit member 42, and a light receiving unit 43. The light source and the light receiving unit 43 are fitted and fixed in a manner that they are spaced from each other and opposed to each other with the slit member 42 interposed therebetween. In the slit member 42, light transmitting portions 42a as the first region and light shielding portions 42b as the second region are arrayed alternately in adjacency to one another along the X direction. The slit member 42, which is disposed between the light source and the light receiving unit 43, is movable relative to the light source and the light receiving unit 43 in an X1 direction (i.e. the rightward direction in FIG. 3) or an X2 direction (i.e. the leftward direction in the figure). That is, the slit member 42, which is fixed to the detection object, moves along the X direction as the detection object moves.

The light receiving unit 43, as shown in FIG. 3, is made up of four light receiving elements 43a, 43b, 43c, 43d implemented by isosceles triangular-shaped photodiodes or the like. The light receiving elements 43a, 43b, 43c, 43d each have an isosceles triangular shape such that they are each actually or imaginarily dividable into two congruent right-angled triangular-shaped light receiving regions C, and the light receiving elements each have an isosceles triangular shape which is formed by adjoining the two congruent right-angled triangles of the light receiving regions C to each other with their right angles set adjacent to each other.

Then, the light receiving regions C each have an interior angle of 90 degrees formed between a dy1-long edge and a dx1-long edge, and are adjacent to other light receiving regions C, with their dy1-long edges being coincident with each other. The dy1-long edge extends along the Y direction, while the dx1-long edge extends along the X direction. Therefore, the X-direction width of each of the light receiving elements 43a-43d is set to a double of the X-direction width dx1 of each of the light receiving elements 4a-4d of the background art encoder device 1 shown in FIG. 6, while the Y-direction length is set to the Y-direction length dy1 of each of the light receiving elements 4a-4d of the background art encoder device 1. Thus, the light reception area of each of the light receiving elements 43a-43d results in (dx1)×(dy1), equal to that of each of the light receiving elements 4a-4d in the background art encoder device 1.

Referring to FIG. 3, output signals of the light receiving elements 43a, 43c are compared with each other by a comparator 44, and a comparison result thereof is outputted as a detection signal VoutA from a terminal 45. Also, output signals of the light receiving elements 43b, 43d are compared with each other by a comparator 46, and a comparison result thereof is outputted as a detection signal VoutB from a terminal 47.

In this case, when the slit member 42 moves at a constant speed in an X1 direction relative to the light receiving unit 43, output signals and detection signals of the light receiving elements 43a-43d show changes as described with reference to FIG. 2 in the first embodiment. Thus, jitter at leading edges and trailing edges of the detection signals VoutA, VoutB can be greatly reduced.

Also, in this embodiment, in a rectangular region having an area of 4×(dx1)×(dy1), a total light reception area of 4×(dx1)×(dy1) of the light receiving elements 43a-43d can be obtained. Thus, the light reception efficiency becomes 100%, showing an achievement of great improvement as compared with the light reception efficiency 50% of the background art encoder device 1 disclosed in Patent Document 1.

### Third Embodiment

FIG. 4 shows a planar construction of a photoelectric encoder 51 of this embodiment.

This photoelectric encoder 51 is made up roughly of a light source (not shown), a slit member 52, and a light receiving unit 53. The light source and the light receiving unit 53 are fitted and fixed in a manner that they are spaced from each other and opposed to each other with the slit member 52 interposed therebetween. In the slit member 52, light transmitting portions 52a as the first region and light shielding portions 52b as the second region are arrayed alternately in adjacency to one another along an X direction. The slit member 52, which is disposed between the light source and the light receiving unit 53, is movable relative to the light source and the light receiving unit 53 in an X1 direction (i.e. the rightward direction in FIG. 4) or an X2 direction (i.e. the leftward direction in the figure). That is, the slit member 52, which is fixed to a detection object, moves along the X direction as the detection object moves.

The light receiving unit 53, as shown in FIG. 4, is made up of four light receiving elements 53a, 53b, 53c, 53d implemented by parallelogram-shaped photodiodes or the like. The light receiving elements 53a, 53b, 53c, 53d each have a parallelogram shape such that they are each actually or imaginarily dividable into two congruent right-angled triangular-shaped light receiving regions C, and the two congruent right-angled triangles of the light receiving regions are adjoined to each other, with one of two edges making a right angle therebetween of one right-angled triangle being coincident with a corresponding edge of the other right-angled triangle so that the right angle of the one right-angled triangle and a non-right angle of the other right-angled triangle are adjacent to each other, forming one angle of the parallelogram.

The light receiving regions C each have an interior angle of 90 degrees formed between a dy1-long edge and a dx1-long edge, and are arranged adjacent to other light receiving regions C with their dy1-long edges being coincident with each other. A point which the dy1-long edge meets is a vertex at which the right angle and the non-right angle adjoin each other. Therefore, the X-direction width of each of the light receiving elements 53a-53d is set to the X-direction width dx1 of each of the light receiving elements 4a-4d of the background art encoder device 1 shown in FIG. 6, while the Y-direction length is set to the Y-direction length dy1 of each of the light receiving elements 4a-4d of the background art encoder device 1. Thus, the light reception area of each of the light receiving elements 53a-53d results in (dx1)×(dy1), equal to that of each of the light receiving elements 4a-4d in the background art encoder device 1.

Referring to FIG. 4, output signals of the light receiving elements 53a, 53c are compared with each other by a comparator 54, and a comparison result thereof is outputted as a detection signal VoutA from a terminal 55. Also, output signals of the light receiving elements 53b, 53d are compared with each other by a comparator 56, and a comparison result thereof is outputted as a detection signal VoutB from a terminal 57.

In this case, when the slit member 52 moves at a constant speed in the X1 direction relative to the light receiving unit 53, output signals and detection signals of the light receiving elements 53a-53d show changes, as described with reference to FIG. 2 in the first embodiment. Thus, jitter at leading edges and trailing edges of the detection signals VoutA, VoutB can be greatly reduced.

Also, in this embodiment, the light receiving elements 53a-53d are so shaped as to be in point symmetry. Therefore, the light receiving elements 53a-53d can be arranged successively, with no gaps therebetween, along the X direction without inverting their orientation. Thus, biases among output signals of the light receiving elements 53a-53d can be reduced.

Also, in this embodiment, in a rectangular region having an area of 4×(dx1)×(dy1), a total light reception area of 4×(dx1)×(dy1) of the light receiving elements 53a-53d can be obtained. Thus, the light reception efficiency becomes 100%, showing an achievement of great improvement as compared with the light reception efficiency 50% of the background art encoder device 1 disclosed in Patent Document 1.

### Fourth Embodiment

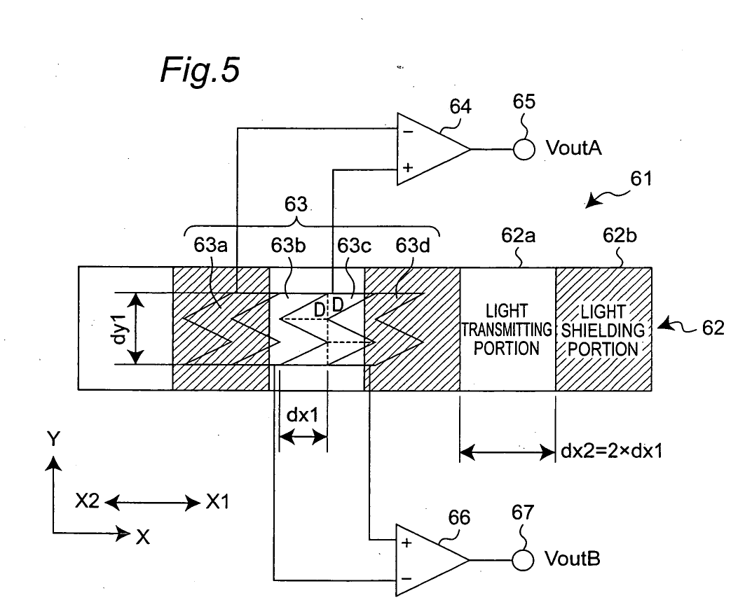

FIG. 5 shows a planar construction of a photoelectric encoder 61 of the fourth embodiment.

The photoelectric encoder 61 is made up roughly of a light source (not shown), a slit member 62, and a light receiving unit 63. The light source and the light receiving unit 63 are fitted and fixed in a manner that they are spaced from each other and opposed to each other with the slit member 62 interposed therebetween. In the slit member 62, light transmitting portions 62a as the first region and light shielding portions 62b as the second region are arrayed alternately in adjacency to one another along the X direction. The slit member 62, which is disposed between the light source and the light receiving unit 63, is movable relative to the light source and the light receiving unit 63 in an X1 direction (i.e. the rightward direction in FIG. 6) or an X2 direction (i.e. the leftward direction in the figure). That is, the slit member 62, which is fixed to a detection object, moves along the X direction as the detection object moves.

The light receiving unit 63, as shown in FIG. 5, is made up of four light receiving elements 63a, 63b, 63c, 63d implemented by zigzag-shaped photodiodes or the like. Each of the light receiving elements 63a, 63b, 63c, 63d can actually or imaginarily be divided into two congruent right-angled triangular-shaped light receiving regions D. The light receiving elements 63a, 63b, 63c, 63d each have a zigzag shape which is formed by linking m (m=3) parallelograms in the Y direction. An edge of one parallelogram is coincident with a corresponding edge of another parallelogram and these two parallelograms light receiving regions are in line symmetry with respect to the coincident edges. Each parallelogram-shaped light receiving region consists of two congruent right-angled triangular light receiving regions D which adjoin each other, with one of two edges making a right angle therebetween of one right-angled triangle being coincident with a corresponding edge of the other right-angled triangle so that the right angle of one right-angled triangle and a non-right angle of the other right-angled triangle are adjacent to each other.

Then, the light receiving regions D each have an interior angle of 90 degrees formed between a dy1÷m (m=3)-long edge and a dx1-long edge, and are adjacent to other light receiving regions D with their dy1÷m (m=3)-long edges coincident with each other. A point that the dy1÷m (m=3)-long edge meets is a vertex at which the right angle and the non-right angle adjoin each other. Further, m (m=3) parallelograms each formed by adjoining two light receiving regions D are set in adjacency to one another in the Y direction so as to be in line symmetry with respect to the dx1-long edge making a right angle with the dy1÷m (m=3)-long edge. In other words, two parallelograms adjoin each other such that the same angle vertices are set in adjacency to each other. Therefore, the X-direction width of each of the light receiving elements 63a-63d is set to a double of the X-direction width dx1 of each of the light receiving elements 4a-4d of the background art encoder device 1 shown in FIG. 6, while the Y-direction length is set to the Y-direction length dy1 of each of the light receiving elements 4a-4d of the background art encoder device 1.

However, each of the light receiving elements 63a-63d has a zigzag shape having an amplitude of dx1. Therefore, the light reception area of each of the light receiving elements 63a-63d is (dx1)×(dy1), which is equal to that of each of the light receiving elements 4a-4d of the background art encoder device 1.

Referring to FIG. 5, output signals of the light receiving elements 63a, 63c are compared with each other by a comparator 64, and a comparison result thereof is outputted as a detection signal VoutA from a terminal 65. Also, output signals of the light receiving elements 63b, 63d are compared with each other by a comparator 66, and a comparison result thereof is outputted as a detection signal VoutB from a terminal 67.

In this case, when the slit member 62 moves at a constant speed in an X1 direction relative to the light receiving unit 63, output signals and detection signals of the light receiving elements 63a-63d show changes, as described with reference to FIG. 2 in the first embodiment. Thus, jitter at leading edges and trailing edges of the detection signals VoutA, VoutB can be greatly reduced.

Also, in this embodiment, edges of the light receiving elements 63a-63d which are not parallel to borders between the light transmitting portions 62a and the light shielding portions 62b of the slit member 62 can be subdivided into lengths of an oblique side of each light receiving region D. Therefore, quantities of incident light to the light receiving elements 63a-63d, i.e. output signals from the light receiving elements 63a-63d, can be averaged.

Also, in this embodiment, the light receiving elements 63a-63d are so shaped as to be in point symmetry. Therefore, the light receiving elements 63a-63d can be arranged successively in the X direction without inverting their direction. Thus, biases among output signals of the light receiving elements 63a-63d can be reduced.

Also, in this embodiment, in a rectangular region having an area of 4×(dx1)×(dy1), a total light reception area of 4×(dx1)×(dy1) of the light receiving elements 63a-63d can be obtained. Thus, the light reception efficiency becomes 100%, showing an achievement of great improvement as compared with the light reception efficiency 50% of the background art encoder device 1 disclosed in Patent Document 1.

The foregoing individual embodiments have been described on the assumption that n=2. However, by the arrangement that (2×n) (where n is an integer satisfying that n≧2) light receiving elements are arranged successively at a pitch of one (2×n)-th (i.e. 1/(2×n)) of one pitch P of the first regions (light transmitting portions) or the second regions (light shielding portions) in a movable member, it becomes possible to obtain abrupt leading and trailing edges of (2×n) output signals for the signal processing part which differ in phase from each other by 360°/(2×n) and which have a cycle period of T.

Therefore, needless to say, it becomes possible to reduce jitter of two rectangular waves which differ in phase from each other by 360°/2n and each of which has a cycle period of (2/n)T, the rectangular waves being produced every one cycle T in which the first region and the second region move by the one pitch P.

Also, although the foregoing embodiments have been described by taking an example of a light transmission type photoelectric encoder, yet it is a matter of course that the invention is not limited to that. The invention is similarly applicable to light reflection type photoelectric encoders as well. In this case, it is enough that the first region and the second region are set different in optical reflectance from each other.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A photoelectric encoder, comprising:
a light emitting part;
a light receiving part for receiving light emitted from the light emitting part; and
a movable member in which first regions for transmitting or reflecting light emitted from the light emitting part toward the light receiving part and second regions different in light transmittance or optical reflectance from the first regions are alternately arrayed along a moving direction of the movable member, borders between the first regions and the second regions extending along a direction perpendicular to the moving direction, wherein
the light receiving part comprises a plurality of identical light receiving elements which are arranged along the moving direction of the movable member,
the light receiving elements are shaped such that each light receiving element is actually or imaginarily dividable into two congruent triangular light receiving regions and that the two congruent triangular light receiving regions are adjacent to each other, with an edge of one triangular light receiving region being coincident with a corresponding edge of the other triangular light receiving region, and
opposite edges in the moving direction of each of the light receiving elements are parallel to or coincident with edges of the light receiving elements adjoining thereto in the moving direction, and moreover inclined at a non-right angle with respect to the moving direction.

2. The photoelectric encoder as claimed in claim 1, wherein
the light receiving elements making up the light receiving part each have a parallelogram shape.

3. The photoelectric encoder as claimed in claim 1, wherein
the two congruent triangular light receiving regions, into which each of the light receiving elements is actually or imaginarily dividable, each have a shape of a right-angled triangle, and
the light receiving elements each have an isosceles triangular shape which is formed by adjoining the two congruent right-angled triangles of the light receiving regions to each other with their 90-degree angles set adjacent to each other.

4. The photoelectric encoder as claimed in claim 2, wherein
the two congruent triangular light receiving regions, into which each of the light receiving elements is actually or imaginarily dividable, each have a shape of a right-angled triangle, and
the light receiving elements each have a shape in which the two congruent right-angled triangles of the light receiving regions are adjoined to each other, with one of two edges making a right angle therebetween of one right-angled triangle being coincident with a corresponding edge of the other right-angled triangle so that the right angle of one right-angled triangle and a non-right angle of the other right-angled triangle are adjacent to each other.

5. The photoelectric encoder as claimed in claim 4, wherein
the light receiving elements each have a zigzag shape in which a plurality of the parallelogram-shaped light receiving regions, each formed of two adjoining congruent right-angled triangular light receiving regions, are combined in such a manner that an edge of one parallelogram-shaped light receiving region is coincident with a corresponding edge of another parallelogram-shaped light receiving region and that these two light receiving regions are in line symmetry with respect to the coincident edges.

6. The photoelectric encoder as claimed in claim 1, wherein
the light receiving elements are arranged successively in a quantity of (2×n), where n is an integer satisfying that n≧2, at a pitch which is one (2×n)-th of an array pitch P of the first regions or the second regions in the movable member, and
the photoelectric encoder further comprises a signal processing part for, based on output signals from the (2×n) light receiving elements, generating two rectangular waves which differ in phase from each other by 360°/2n and each of which has a cycle period of (2/n)×T, the rectangular waves being produced every one cycle T in which the first regions and the second regions in the movable member move by the array pitch P.

7. Electronic equipment including the photoelectric encoder as defined in claim 1.
